(19) United States
(12) Patent Application Publication
(10) Pub. No.: US 2022/0366156 A1
(43) Pub. Date: Nov. 17, 2022

(54) TRANSLATION SYSTEM, TRANSLATION APPARATUS, TRANSLATION METHOD, AND TRANSLATION PROGRAM

(71) Applicant: NEC Corporation, Minato-ku, Tokyo (JP)

(72) Inventor: Yoshimasa NARUMIYA, Tokyo (JP)

(73) Assignee: NEC Corporation, Minato-ku, Tokyo (JP)

(21) Appl. No.: 17/624,904

(22) PCT Filed: Jul. 8, 2020
(86) PCT No.: PCT/JP2020/026736

§ 371 Date: Jun. 29, 2022

(30) Foreign Application Priority Data
Jul. 10, 2019 (JP) 2019-128044

(51) Int. Cl. G06F 40/58; H04R 1/32; G06T 7/70; G10L 15/00; G10L 15/22; G10L 15/25; H04R 1/40; H04R 3/12; H04R 3/00

(52) U.S. Cl. CPC G06F 40/58; H04R 1/323; H04R 1/326; G06T 7/70; G10L 15/005; G10L 15/22; G10L 15/25; H04R 1/403; H04R 3/12; H04R 1/406; H04R 3/005; G06T 2207/30201; H04R 2430/01

(57) ABSTRACT

The present invention contributes to reducing the burden on a user while preventing speeches translated into a plurality of languages from interfering with each other. A translation system comprises a camera that obtains surroundings information; a directional speaker that is movable so as to output sound toward a specified position; a directional microphone that is movable so as to receive sound from a specified position; and a translation apparatus that determines a location of a user from the surroundings information obtained by the camera, moves the directional speaker and the directional microphone toward the location of the user, identifies the language of a speech received by the directional microphone, translates the language into another language to output the translated language from another directional speaker, and retranslates the translation in the another language into the language to output the retranslated language from the directional speaker.

### TECHNICAL FIELD

### Reference to Related Application

The present invention is based upon and claims the benefit of the priority of Japanese patent application No. 2019-128044 filed on Jul. 10, 2019, the disclosure of which is incorporated herein in its entirety by reference thereto.

The present invention relates to a translation system, translation apparatus, translation method, and translation program.

### BACKGROUND

A conventional hands-free translation terminal achieves speech translation by having the speaker speaks into the translation terminal in the source language, translating the speech in the terminal, and having the listener hear the translated speech outputted from the translation terminal. Such a hands-free translation terminal is characterized by a speech detection method that enables it to be used without the use of hands, and it is mainly intended for one-on-one conversations, simply outputting the translated information from the speaker of the terminal.

Patent Literature 1 describes a speech translation apparatus that translates a two-way dialogue using directional speakers. Patent Literature 2 describes that, in a speech translation apparatus using a directional microphone, the directivity of the microphone is automatically controlled. Patent Literature 3 describes a translation apparatus that identifies the native language of a speaker on the basis of the speaker's speech data.

### CITATION LIST

### Patent Literature

### [Patent Literature 1]

Japanese Patent Kokai Publication No. JP2010-026220A

### [Patent Literature 2]

Japanese Patent Kokai Publication No. JP2013-172411A

### [Patent Literature 3]

Japanese Patent Kokai Publication No. JP2012-203477A

### SUMMARY

### Technical Problem

The disclosure of each literature cited above is incorporated herein in its entirety by reference thereto. The following analysis is given by the present inventors.

It is difficult for a translation apparatus to output translated speeches in a plurality of languages because outputted voices will interfere with each other. For instance, if speech in Japanese is translated into English and Chinese, translations in both languages will be outputted at the same time, making it difficult for the listeners to hear them. If the translations are outputted nonconcurrently, there will be a time lag in the conversation. As a result, it is difficult to simultaneously translate three or more people speaking in different languages (simultaneous translation in three or more languages).

Further, since translated information is simply outputted from the speaker of the terminal, the speaker who does not understand the language of the translation cannot tell if the translation is correct and will not notice even if the translation is not as intended. For instance, if the listener cannot understand the content of the translated speech, the speaker is unable to determine if this is caused by the original speech being entered incorrectly, an incorrect translation, or the listener unable to understand the content of the correct translation.

The problems above may be avoided by using earphones to prevent translated speeches from interfering with each other or by displaying information regarding translation on the terminal screen, however, a new problem may arise such as these solutions are not suitable when one wants to casually participate in a conversation so short that it feels inconvenient to have to set up the device or when one needs to have an urgent conversation (no time to set up the device).

In view of the above problems, it is an object of the present invention to provide a translation system, translation apparatus, translation method, and translation program that contribute to reducing the burden on a user while preventing speeches translated into a plurality of languages from interfering with each other.

### Solution to Problem

According to a first aspect of the present invention, there is provided a translation system comprising a camera that obtains surroundings information; a directional speaker that is movable so as to output sound toward a specified position; a directional microphone that is movable so as to receive sound from a specified position; and a translation apparatus that determines a location of a user from the surroundings information obtained by the camera, moves the directional speaker and the directional microphone toward the location of the user, identifies the language of a speech received by the directional microphone, translates the language into another language to output the translated language from another directional speaker, and retranslates the translation in the another language into the language to output the retranslated language from the directional speaker.

According to a second aspect of the present invention, there is provided a translation apparatus outputting sound from a directional speaker on the basis of input from a camera and a directional microphone, the translation apparatus determining a location of a user from surroundings information obtained by the camera, moving the directional speaker and the directional microphone toward the location of the user, identifying the language of a speech received by the directional microphone, translating the language into another language to output the translated language from another directional speaker, and retranslating the translation in the another language into the language to output the retranslated language from the directional speaker.

According to a third aspect of the present invention, there is provided a translation method for outputting sound from a directional speaker on the basis of input from a camera and a directional microphone, the translation method including determining a location of a user from surroundings information obtained by the camera; moving the directional speaker and the directional microphone toward the location of the user; identifying the language of a speech received by the directional microphone; translating the language into another language to output the translated language from another directional speaker; and retranslating the translation in the another language into the language to output the retranslated language from the directional speaker.

According to a fourth aspect of the present invention, there is provided a translation program executed by a translation apparatus that outputs sound from a directional speaker on the basis of input from a camera and a directional microphone, the translation program executing a process of determining a location of a user from surroundings information obtained by the camera; a process of moving the directional speaker and the directional microphone toward the location of the user; a process of identifying the language of a speech received by the directional microphone; a process of translating the language into another language to output the translated language from another directional speaker; and a process of retranslating the translation in the another language into the language to output the retranslated language from the directional speaker. Further, this program can be stored in a computer-readable storage medium. The storage medium may be a non-transient one such as a semiconductor memory, a hard disk, a magnetic recording medium, an optical recording medium, and the like. The present invention can also be realized as a computer program product.

### Advantageous Effects of Invention

According to each aspect of the present invention, there can be provided a translation system, translation apparatus, translation method, and translation program that contribute to reducing the burden on a user while preventing speeches translated into a plurality of languages from interfering with each other.

### BRIEF DESCRIPTION OF DRAWINGS

FIG. 1 is a drawing illustrating a configuration example of a translation system relating to a first example embodiment.

FIG. 2 is a drawing showing an example of the hardware configuration of an information processing apparatus.

FIG. 3 is a drawing showing an example of the flow of a translation program.

FIG. 4 is a drawing illustrating an example of use of the translation system.

FIG. 5 is a drawing illustrating a configuration example of a translation system relating to a second example embodiment.

FIG. 6 is a sequence diagram showing processes in user location detection and speech input/output preparation.

FIG. 7 is a sequence diagram showing processes from the start of a speech to the identification of a speaker and the language spoken by the speaker.

FIG. 8 is a sequence diagram showing processes of translation and retranslation.

### MODES

Example embodiments of the present invention will be described with reference to the drawings. However, the present invention is not limited to the example embodiments described below. Further, in each drawing, the same or corresponding elements are appropriately designated by the same reference signs. It should be noted that the drawings are schematic, and the dimensional relationships and the ratios between the elements may differ from the actual ones. There may also be parts where the dimensional relationships and the ratios between drawings are different.

### First Example Embodiment

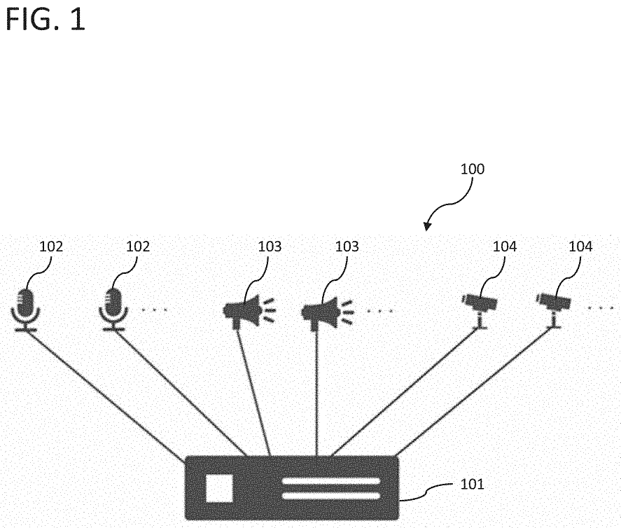

FIG. 1 is a drawing illustrating a configuration example of a translation system relating to a first example embodiment. As shown in FIG. 1, the translation system 100 comprises a camera 104 that obtains surroundings information, a directional speaker 103 that is movable so as to output sound toward a specified position, a directional microphone 102 that is movable so as to receive sound from a specified position, and a translation apparatus 101 that outputs sound from the directional speaker 103 on the basis of input from the camera 104 and the directional microphone 102.

It is preferred that the translation system 100 comprise at least three sets of the cameras 104, the directional speakers 103, and the directional microphones 102 and assign each set of a camera 104, a directional speaker 103, and a directional microphone 102 to each user. In other words, although FIG. 1 shows two cameras 104, two directional speakers 103, and two directional microphones 102, it is preferred that the number of sets of the cameras 104, the directional speakers 103, and the directional microphones 102 be increased or decreased according to the number of users, without being limited thereto.

The translation apparatus 101 has functions of determining the location of a user from the surroundings information obtained by the camera 104, moving the directional speaker 103 and the directional microphone 102 toward the location of the user, identifying the language of a speech (first language) received by the directional microphone 102, translating the language (the first language) into another language (second language) to output the result from another directional speaker 103, and further retranslating the translation in the another language (the second language) into the original language (the first language) to output the result from the directional speaker.

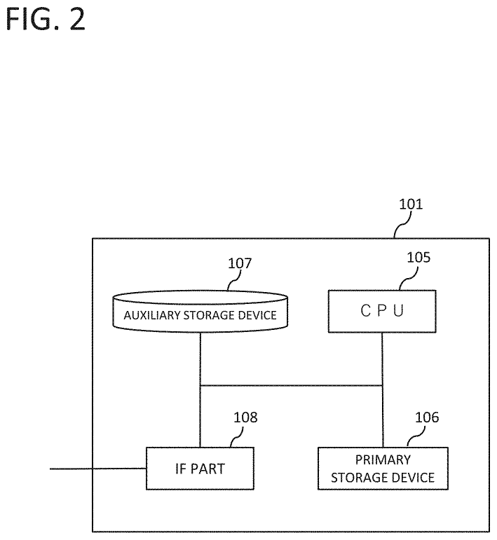

For instance, the translation apparatus 101 may be realized by running a translation program on an information processing apparatus having a hardware configuration shown in FIG. 2, which is a drawing showing an example of the hardware configuration of the information processing apparatus. Note that the hardware configuration example shown in FIG. 2 is merely an example of a hardware configuration that achieves the function of the translation apparatus 101 and is not intended to limit the hardware configuration of the translation apparatus 101, which may include hardware not shown in FIG. 2.

As shown in FIG. 2, the hardware configuration of the translation apparatus 101 comprises a CPU (Central Processing Unit) 105, a primary storage device 106, an auxiliary storage device 107, and an IF (interface) part 108. These elements are connected to each other by, for instance, an internal bus.

The CPU 105 executes the translation program running on the translation apparatus 101. The primary storage device 106 is, for instance, a RAM (Random Access Memory) and temporarily stores the translation program executed by the translation apparatus 101 so that the CPU 105 can process it.

The auxiliary storage device 107 is, for instance, an HDD (Hard Disk Drive) and is capable of storing the translation program executed by the translation apparatus 101 in the medium to long term. The translation program may be provided as a program product stored in a non-transitory computer-readable storage medium. The auxiliary storage device 107 can be used to store the translation program stored in a non-transitory computer-readable storage medium over the medium to long term.

The IF part 108 provides an interface to the input and output of an external apparatus. For instance, the IF part 108 may be used to connect the cameras 104, the directional speakers 103, and the directional microphones 102 to the translation apparatus 101, as shown in FIG. 1.

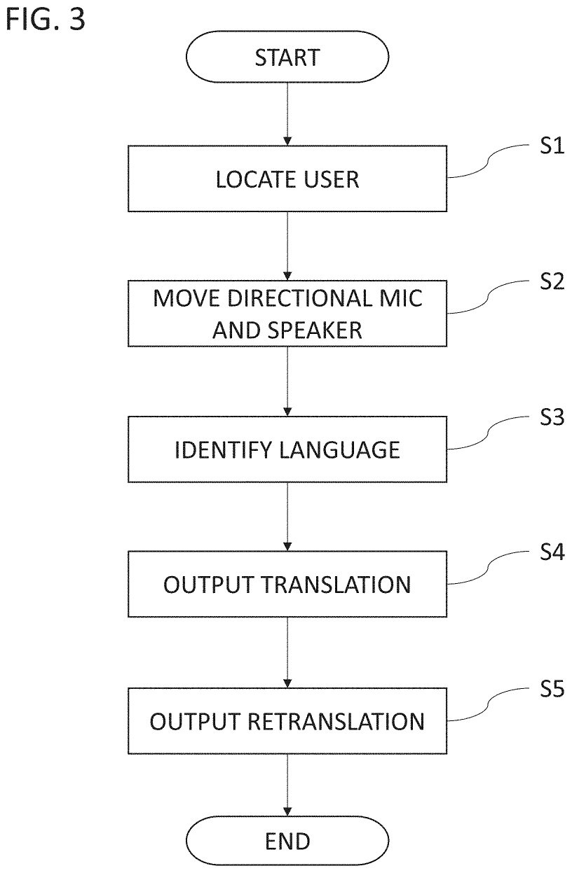

An information processing apparatus employing the hardware configuration as described can be configured as the translation apparatus 101 that outputs speech from a directional speaker on the basis of input from a camera and a directional microphone by executing a translation program having the procedure flow shown in FIG. 3. FIG. 3 is a drawing showing an example of the flow of the translation program.

As shown in FIG. 3, the translation program includes a step of locating a user from the surroundings information obtained by the camera 104 (step S1), a step of moving the directional speaker 103 and the directional microphone 102 toward the location of the user (step S2), a step of identifying the language of a speech received by the directional microphone 102 (step S3), a step of translating this language into another language and outputting the result from another directional speaker 103 (step S4), and a step of retranslating the another language into the original language and outputting the result from the directional speaker 103 (step S5).

The execution of the translation program above gives an example of achieving a translation method for outputting speech from a directional speaker on the basis of input from a camera and a directional microphone. The translation method includes locating a user from the surroundings information obtained by the camera 104, moving the directional speaker 103 and the directional microphone 102 toward the location of the user, identifying the language of a speech (first language) received by the directional microphone 102, translating the language (the first language) into another language (second language) to output the result from another directional speaker 103, and retranslating the another language (the second language) into the first language to output the result from the directional speaker 103.

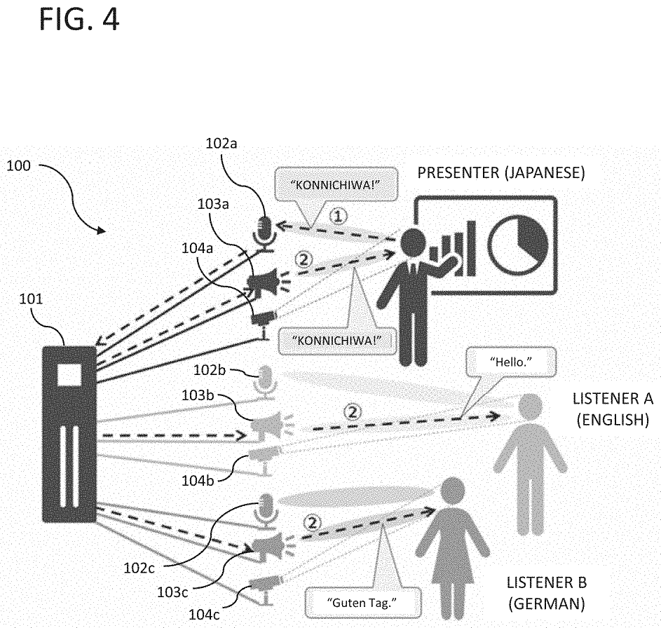

FIG. 4 is a drawing illustrating an example of use of the translation system. The example of FIG. 4 assumes that the translation system 100 is used in a poster session.

As shown in FIG. 4, it is assumed that, for instance, a presenter speaks Japanese, a listener A English, and a listener B German. In other words, in the use example shown in FIG. 4, three or more people speaking different languages are having a conversation.

Further, as shown in FIG. 4, the translation system 100 comprises at least three sets of the cameras 104, the directional speakers 103, and the directional microphones 102. In the translation system 100, a set of a camera 104, a directional speaker 103, and a directional microphone 102 is assigned to each user. More specifically, a set of a camera 104a, a directional speaker 103a, and a directional microphone 102a is assigned to the presenter, a set of a camera 104b, a directional speaker 103b, and a directional microphone 102b to the listener A, and a set of a camera 104c, a directional speaker 103c, and a directional microphone 102c to the listener B.

The camera 104a locates the position of the presenter, and the translation apparatus 101 moves the directional speaker 103a and the directional microphone 102a toward the position of the presenter on the basis of the located position. Likewise, the camera 104b locates the position of the listener A, and the translation apparatus 101 moves the directional speaker 103b and the directional microphone 102b toward the position of the listener A on the basis of the located position. The camera 104c locates the position of the listener B, and the translation apparatus 101 moves the directional speaker 103c and the directional microphone 102c toward the position of the listener B on the basis of the located position.

For instance, when the presenter says, “Konnichiwa!” the translation apparatus 101 receives the speech “Konnichiwa!” via the directional microphone 102a. The translation apparatus 101 identifies the language of the speech received by the directional microphone 102a as Japanese in this case. For instance, the language can be identified from an image of the presenter obtained by the camera 104a using facial recognition technology, or it can be identified by analyzing the speech received by the directional microphone 102a. Further, the fact that the listeners A and B speak English and German, respectively, can be recognized similarly.

Then, the translation apparatus 101 translates “Konnichiwa!” into English and German and outputs the results from the directional speakers 103b and 103c, respectively. More specifically, the translation apparatus 101 outputs “Hello” from the directional speaker 103b and “Guten Tag” from the directional speaker 103c.

Meanwhile, the translation apparatus 101 retranslates “Hello” or “Guten Tag” and outputs the result from the directional speaker 103a. As a result, the presenter is able to recognize that what he or she said was translated correctly and conveyed to the listeners.

Further, as in the above example in which “Hello” or “Guten Tag” is retranslated, when the retranslated language is selected from a plurality of languages, the translation apparatus 101 can select the retranslated language according to the following methods.

In a first method, the language to be used may be set in advance. This method should be used when one wants to ensure that someone speaking a certain language definitely understands the speech. The method should also be used when one wants to preferentially communicate the content of the speech to a group of people speaking a certain language.

In a second method, the language spoken by the most people in a given situation may be automatically selected. This method should be employed when one wishes to reliably communicate the content of the speech to as many people as possible. The method is especially effective when the speaker talks in front of a large number of people, such as in a lecture or poster session.

In a third method, a listener to whom the speaker wants to communicate the speech the most is inferred from the speaker's eyeline and posture, and the language spoken by this listener is automatically selected. For instance, the listener to whom the speaker wants to communicate the speech the most can be inferred from information obtained by the camera 104a. This method should be employed when the speaker wishes to reliably communicate the content of the speech to someone directly engaging in a conversation with the speaker, such as in a meeting or discussion.

As described, in the example shown in FIG. 4, in which the translation system is used in a poster session, three or more people speaking different languages are able to have a simultaneous conversation, and it is possible to grasp the translation results of one's own speech without awkwardly looking at a screen.

### Second Example Embodiment

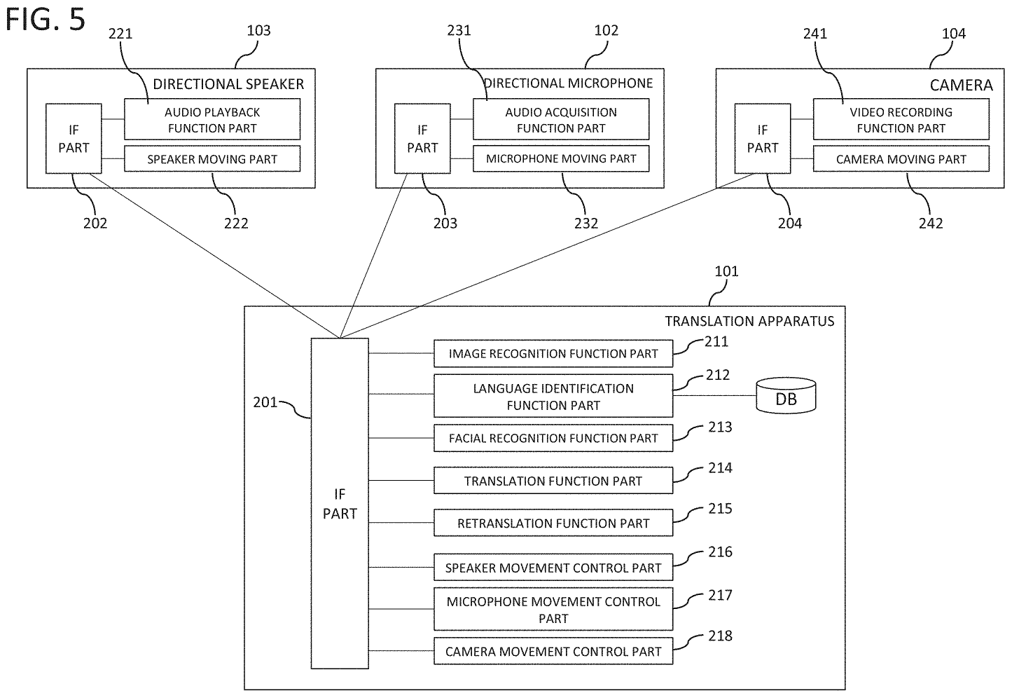

FIG. 5 is a drawing illustrating a configuration example of a translation system relating to a second example embodiment. In the configuration example of the translation system 100 relating to the second example embodiment shown in FIG. 5, the configuration of the translation system 100 relating to the first example embodiment is specified more in detail. Therefore, in the description of the second example embodiment, the same reference signs as those of the first example embodiment will be used, and duplicate descriptions will be appropriately avoided.

As shown in FIG. 5, the translation system 100 comprises the camera 104 that obtains the surroundings information, the directional speaker 103 that is movable so as to output sound toward a specified position, the directional microphone 102 that is movable so as to receive sound from a specified position, and the translation apparatus 101 that outputs sound from the directional speaker 103 on the basis of input from the camera 104 and the directional microphone 102.

The translation apparatus 101 comprises an IF part 201 for connecting to internal and external devices, an image recognition function part 211 that identifies the location of a person nearby using image recognition, a language identification function part 212 that identifies the language of a supplied speech, a facial recognition function part 213 that records and identifies the face of a user on the basis of a supplied video, a translation function part 214 that translates the supplied speech, a retranslation function part 215 that retranslates the translated speech, a speaker movement control part 216 that controls the direction and position of the directional speaker 103, a microphone movement control part 217 that controls the direction and position of the directional microphone 102, and a camera movement control part 218 that controls the direction and position of the camera 104.

The IF part 201 is connected to internal devices such as the image recognition function part 211, the language identification function part 212, the facial recognition function part 213, the translation function part 214, the retranslation function part 215, the speaker movement control part 216, the microphone movement control part 217, and the camera movement control part 218. The IF part 201 is also connected to external devices such as an IF part 202 of the directional speaker 103, an IF part 203 of the directional microphone 102, and an IF part 204 of the camera 104.

The directional speaker 103 comprises the IF part 202 for connecting to internal and external devices, an audio playback function part 221 that directionally plays back audio, and a speaker moving part 222 that moves the direction and position of the speaker. The IF part 202 is connected to the IF part 201 of the translation apparatus 101, the audio playback function part 221, and the speaker moving part 222. It is preferred that the directional speaker 103 be configured to have two or more audio output mechanisms that can be controlled independently and to be able to output audio while adjusting the volume and arrival time differences between the two or more audio output mechanisms as if sound were generated from the location of a user.

The directional microphone 102 comprises the IF part 203 for connecting to internal and external devices, an audio acquisition function part 231 that directionally acquires audio, and a microphone moving part 232 that moves the direction and position of the microphone. The IF part 203 is connected to the IF part 201 of the translation apparatus 101, the audio acquisition function part 231, and the microphone moving part 232.

The camera 104 comprises the IF part 204 for connecting to internal and external devices, a video recording function part 241 that records a video around the terminal, and a camera moving part 242 that moves the direction and position of the camera. The IF part 204 is connected to the IF part 201 of the translation apparatus 101, the video recording function part 241, and the camera moving part 242.

The configuration above allows the translation apparatus 101 to have the functions of determining the location of a user from the surroundings information obtained by the camera 104, moving the directional speaker 103 and the directional microphone 102 toward the location of the user, identifying the language of a speech (first language) received by the directional microphone 102, translating the language (the first language) into another language (second language) to output the result from another directional speaker 103, and further retranslating the translation in the another language (the second language) into the original language (the first language) to output the result from the directional speaker.

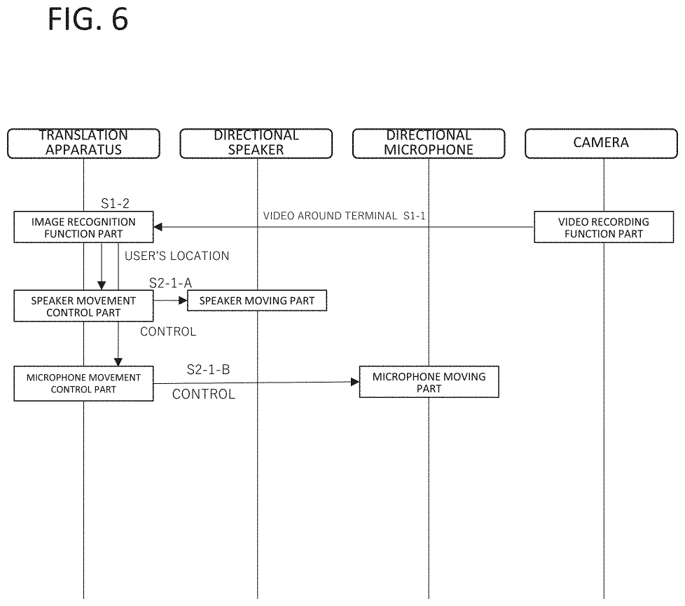

FIG. 6 is a sequence diagram showing processes in user location detection and speech input/output preparation. The sequence diagram in FIG. 6 shows processes performed by the translation apparatus 101, the directional speaker 103, the directional microphone 102, and the camera 104.

First, the video recording function part 241 in the camera 104 obtains a video around the terminal (step S1-1). Then, the image recognition function part 211 in the translation apparatus 101 obtains the video around the terminal from the video recording function part 241 via the IF parts 204 and 201 and detects the location of a user on the basis of the video around the terminal (step S1-2).

Then, on the basis of the location information of the user obtained in the step S1-2, the speaker movement control part 216 in the translation apparatus 101 controls the speaker moving part 222 via the IF parts 201 and 202 and changes the position and direction of the directional speaker 103 so that sound can always be outputted at the position of the user (step S2-1-A).

Meanwhile, on the basis of the location information of the user obtained in the step S1-2, the microphone movement control part 217 in the translation apparatus 101 controls the microphone moving part 232 via the IF parts 201 and 203 and changes the position and direction of the directional microphone 102 so that sound can always be received at the position of the user (step S2-1-B). Note that the processes in the steps S2-1-A and S2-1-B are performed simultaneously.

As described, the translation apparatus 101, the directional speaker 103, the directional microphone 102, and the camera 104 in cooperation detect the location of a user and prepare to receive and output sound.

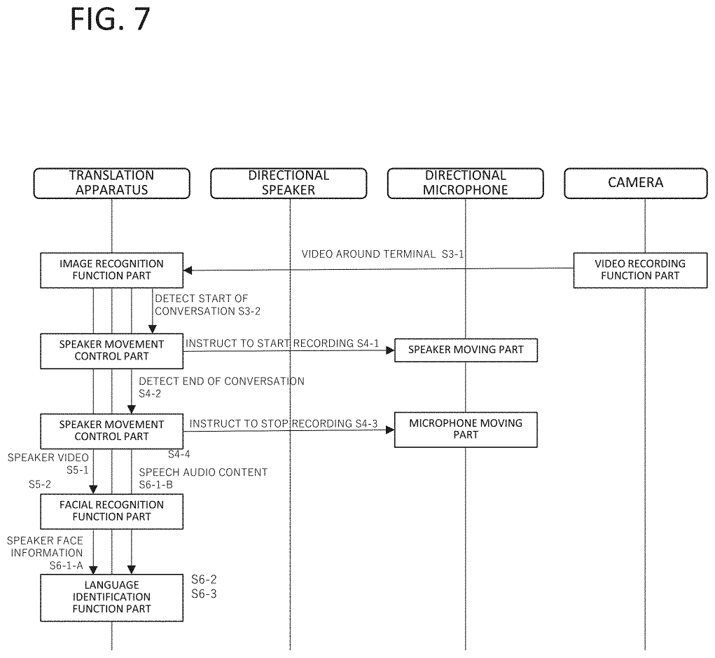

FIG. 7 is a sequence diagram showing processes from the start of a speech to the identification of a speaker and the language spoken by the speaker. As before, the sequence diagram in FIG. 7 shows processes performed by the translation apparatus 101, the directional speaker 103, the directional microphone 102, and the camera 104.

The image recognition function part 211 in the translation apparatus 101 obtains the video around the terminal from the video recording function part 241 via the IF parts 204 and 201 (step S3-1). Then, the image recognition function part 211 in the translation apparatus 101 detects the start of the user's speech and the speaker from the movement of the mouth on the basis of the video around the terminal obtained in the step S3-1 (step S3-2). When detecting the start of the user's speech and the speaker, the procedure proceeds to processes in subsequent steps S4-1 and S5-1.

In the step S4-1, via the IF parts 201 and 203, the speaker movement control part 216 in the translation apparatus 101 instructs the audio acquisition function part 231 to start obtaining audio and prepares to perform a process in step S4-2 (the step S4-1). Then, the image recognition function part 211 in the translation apparatus 101 detects the end of the user's speech from the movement of the mouth on the basis of the video around the terminal obtained in the step S3-1 (the step S4-2). Further, the procedure proceeds to a process in step S4-3 when detecting the end of the user's speech.

Via the IF parts 201 and 203, the speaker movement control part 216 in the translation apparatus 101 instructs the audio acquisition function part 231 to stop obtaining audio (the step S4-3). Then, the audio acquisition function part 231 obtains the audio content of the speech from the start to the end of audio acquisition using the directional microphone 102 on the basis of the audio acquisition start information specified in the step S4-1 and the audio acquisition end information specified in the step S4-3 (step S4-4).

Meanwhile, in the step S5-1, the image recognition function part 211 in the translation apparatus 101 transmits a video of the speaker to the facial recognition function part 213 via the IF part 201 on the basis of the information of the speaker detected in the step S3-2 (the step S5-1). Then, the facial recognition function part 213 in the translation apparatus 101 obtains face information of the speaker on the basis of the video of the speaker obtained in the step S5-1 (step S5-2).

Then, the facial recognition function part 213 in the translation apparatus 101 transmits the face information of the speaker to the language identification function part 212 via the IF part 201 on the basis of the face information of the speaker detected in the step S5-2 (step S6-1-A). Further, the language identification function part 212 in the translation apparatus 101 obtains the audio content of the speech acquired in the step S4-4 from the audio acquisition function part 231 via the IF parts 201 and 203 (step S6-1-B).

The language identification function part 212 in the translation apparatus 101 identifies the language of the speech audio content on the basis of the audio content of the speech obtained in the step S6-1-B (step S6-2). On the basis of the face information of the speaker obtained in the step S6-1-A and the language of the speech audio content obtained in the step S6-2, the language identification function part 212 in the translation apparatus 101 stores data linking the face information of the terminal user to the language spoken by the user in a database within the language identification function part 212 (step S6-3).

As described, the translation apparatus 101, the directional speaker 103, the directional microphone 102, and the camera 104 in cooperation perform the processes from the start of a speech to the identification of a speaker and the language spoken by the speaker.

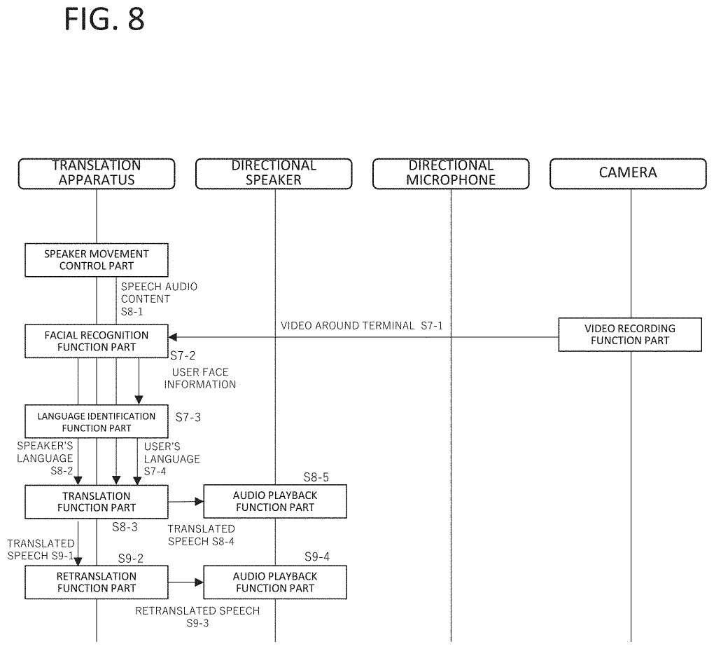

FIG. 8 is a sequence diagram showing processes of translation and retranslation. As before, the sequence diagram in FIG. 8 shows processes performed by the translation apparatus 101, the directional speaker 103, the directional microphone 102, and the camera 104.

The facial recognition function part 213 in the translation apparatus 101 obtains the video around the terminal from the video recording function part 241 via the IF parts 204 and 201 (step S7-1). Then, the facial recognition function part 213 in the translation apparatus 101 performs facial recognition on the basis of the video around the terminal obtained in the step S7-1 and obtains the face information of a terminal user (step S7-2).

The facial recognition function part 213 in the translation apparatus 101 checks the data linking the face information of the terminal user to the language spoken by the user stored in the database within the language identification function part 212 on the basis of the face information of the terminal user obtained in the step S7-2, and obtains the language spoken by each terminal user (step S7-3). When a terminal user does not have data linking the user's face information to the language spoken by the user stored, a preset language is obtained as the language spoken by the terminal user.

Then, the facial recognition function part 213 in the translation apparatus 101 transmits the language of each terminal user obtained in the step S7-3 to the translation function part 214 via the IF part 201 (step S7-4).

The translation function part 214 in the translation apparatus 101 obtains the audio content of the speech acquired in the step S4-4 from the audio acquisition function part 231 via the IF parts 201 and 203 (step S8-1). Then, the translation function part 214 in the translation apparatus 101 obtains the language of the speech audio content acquired in the step S6-2 from the language identification function part 212 via the IF part 201 (step S8-2).

The translation function part 214 in the translation apparatus 101 translates the speech audio content obtained in the step S8-1 from the language of the speech audio content obtained in the step S8-2 into the language of each terminal user obtained in the step S7-4 and obtains the audio content of the translated speech (step S8-3).

Then, the translation function part 214 in the translation apparatus 101 transmits the audio content of the translated speech obtained in the step S8-3 to the audio playback function part 221 via the IF parts 201 and 202 (step S8-4). Next, the audio playback function part 221 in the directional speaker 103 plays back the audio content of the translated speech obtained in the step S8-4 (step S8-5).

Further, the translation function part 214 in the translation apparatus 101 transmits the language of the speech audio content obtained in the step S8-2, the language of each terminal user obtained in the step S7-4, and the audio content of the translated speech obtained in the step S8-3 to the retranslation function part 215 via the IF part 201 (step S9-1).

Then, the retranslation function part 215 in the translation apparatus 101 translates the audio content of the translated speech obtained in the step S9-1 from the language of each terminal user obtained in the step S7-4 into the language of the speech audio content obtained in the step S8-2 to acquire the audio content of the retranslated speech (step S9-2). For instance, a language that is not the language of the speech audio content and is spoken by the largest number of current terminal users may be selected from the languages spoken by the terminal users.

Then, the retranslation function part 215 in the translation apparatus 101 transmits the audio content of the retranslated speech obtained in the step S9-2 to the audio playback function part 221 via the IF parts 201 and 202 (step S9-3). Next, the audio playback function part 221 in the directional speaker 103 plays back the audio content of the retranslated speech obtained in the step S9-3 (step S9-4).

As described, the translation apparatus 101, the directional speaker 103, the directional microphone 102, and the camera 104 in cooperation perform the process of translation and retranslation.

Further, with respect to the series of processes described with reference to FIGS. 6 to 8, the following holds true. The steps S1-1 to S2-1-B are a series of processes. In addition, the series of processes from the steps S1-1 to S2-1-B are repeated so that they are always performed.

The steps S3-1 to S9-4 are a series of processes. Further, the series of processes from the steps S3-1 to S9-4 are repeated so that they are always performed.

With respect to the series of processes from the steps S1-1 to S2-1-B, a plurality of processes may be simultaneously performed in parallel. Further, with respect to the series of processes from the steps S3-1 to S9-4, a plurality of processes may be simultaneously performed in parallel. The series of processes from the steps S1-1 to S2-1-B are simultaneously performed in parallel with the series of processes from the steps S3-1 to S9-4.

According to the translation system, the translation apparatus, the translation method, and the translation program described above, it is possible to input/output a translation of what the speaker has said and a translation in the language spoken by each listener without having a plurality of people interfering with each other and without having to configure settings in advance or having to check the terminal screen. In other words, unlike with a conventional translation terminal, three or more people speaking different languages are able to have a simultaneous conversation, and it is possible to grasp the translation results of one's own speech without awkwardly looking at the screen. Further, the user is able to use the terminal without configuring settings in advance such as presetting a language. By implementing the translation system, the translation apparatus, the translation method, and the translation program described above, even while using the terminal as a translator, a simultaneous conversation with many people, a conversation with gestures, free movement during a conversation, a conversation in which the interlocutors are looking at each other, and sudden participation in a conversation become possible as if having a conversation without the translation terminal.

Further, the translation function, the image recognition function, and the facial recognition function described above may also be executed by a cloud server outside the terminal. Instead of fixedly setting up the camera 104, the directional microphone 102, or the directional speaker 103, a configuration using the camera, microphone, and speaker built in a mobile terminal carried by each user is also possible.

Further, some or all of the example embodiments above can be described as (but not limited to) the following modes.

### [Supplementary Note 1]

A translation system comprising:
a camera that obtains surroundings information;
a directional speaker that is movable so as to output sound toward a specified position;
a directional microphone that is movable so as to receive sound from a specified position; and
a translation apparatus that determines a location of a user from the surroundings information obtained by the camera, moves the directional speaker and the directional microphone toward the location of the user, identifies the language of a speech received by the directional microphone, translates the language into another language to output the translated language from another directional speaker, and retranslates the translation in the another language into the language to output the retranslated language from the directional speaker.

### [Supplementary Note 2]

The translation system preferably according to Supplementary Note 1 identifying the language of a speech received by the directional microphone from a face image of the user obtained by the camera.

### [Supplementary Note 3]

The translation system preferably according to Supplementary Note 1 or 2, wherein the another directional speaker is constituted by two or more directional speakers and outputs the another language by adjusting the volume and arrival time differences between the two or more directional speakers as if the sound were generated from the location of the user.

### [Supplementary Note 4]

The translation system preferably according to any one of Supplementary Notes 1 to 3 comprising at least three sets of the cameras, the directional speakers, and the directional microphones and assigning each of the sets to each user.

### [Supplementary Note 5]

The translation system preferably according to Supplementary Note 4 selecting a preset language as the another language and retranslating the selected language.

### [Supplementary Note 6]

The translation system preferably according to Supplementary Note 4 selecting a language spoken by the most users as the another language and retranslating the selected language.

### [Supplementary Note 7]

The translation system preferably according to Supplementary Note 4 selecting a language inferred from information obtained by the camera as the another language and retranslating the selected language.

### [Supplementary Note 8]

A translation apparatus outputting sound from a directional speaker on the basis of input from a camera and a directional microphone, the translation apparatus determining a location of a user from surroundings information obtained by the camera, moving the directional speaker and the directional microphone toward the location of the user, identifying the language of a speech received by the directional microphone, translating the language into another language to output the translated language from another directional speaker, and retranslating the translation in the another language into the language to output the retranslated language from the directional speaker.

### [Supplementary Note 9]

The translation apparatus preferably according to Supplementary Note 8 identifying the language of a speech received by the directional microphone from a face image of the user obtained by the camera.

### [Supplementary Note 10]

A translation method for outputting sound from a directional speaker on the basis of input from a camera and a directional microphone, the translation method including:
determining a location of a user from surroundings information obtained by the camera;
moving the directional speaker and the directional microphone toward the location of the user;
identifying the language of a speech received by the directional microphone;
translating the language into another language to output the translated language from another directional speaker; and
retranslating the translation in the another language into the language to output the retranslated language from the directional speaker.

### [Supplementary Note 11]

The translation method preferably according to Supplementary Note 10 identifying the language of a speech received by the directional microphone from a face image of the user obtained by the camera.

### [Supplementary Note 12]

A translation program executed by a translation apparatus that outputs sound from a directional speaker on the basis of input from a camera and a directional microphone, the translation program executing:
a process of determining a location of a user from surroundings information obtained by the camera;
a process of moving the directional speaker and the directional microphone toward the location of the user;
a process of identifying the language of a speech received by the directional microphone;
a process of translating the language into another language to output the translated language from another directional speaker; and
a process of retranslating the translation in the another language into the language to output the retranslated language from the directional speaker.

### [Supplementary Note 13]

The translation program preferably according to Supplementary Note 12 identifying the language of a speech received by the directional microphone from a face image of the user obtained by the camera.

Further, the disclosure of each Patent Literature cited above is incorporated herein in its entirety by reference thereto and can be used as a basis or a part of the present invention as needed. It is to be noted that it is possible to modify or adjust the exemplary embodiments or examples within the scope of the whole disclosure of the present invention (including the Claims) and based on the basic technical concept thereof. Further, it is possible to variously combine or select (or partially remove) a wide variety of the disclosed elements (including the individual elements of the individual claims, the individual elements of the individual exemplary embodiments or examples, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof.

### REFERENCE SIGNS LIST

100: translation system
101: translation apparatus
103, 103a to 103c: directional speaker
102, 102a to 102c: directional microphone
104, 104a to 104c: camera
105: CPU
106: primary storage device
107: auxiliary storage device
108, 201, 202, 203, 204: IF part
211: image recognition function part
212: language identification function part
213: facial recognition function part
214: translation function part
215: retranslation function part
216: speaker movement control part
217: microphone movement control part
218: camera movement control part
221: audio playback function part
222: speaker moving part
231: audio acquisition function part
232: microphone moving part
241: video recording function part
242: camera moving part

1. A translation system comprising:
a camera that obtains surroundings information;
a directional speaker that is movable so as to output sound toward a specified position;
a directional microphone that is movable so as to receive sound from a specified position; and
a translation apparatus that determines a location of a user from the surroundings information obtained by the camera, moves the directional speaker and the directional microphone toward the location of the user, identifies a language of a speech received by the directional microphone, translates the language into another language to output the translated language from another directional speaker, and retranslates the translation in the another language into the language to output the retranslated language from the directional speaker.

2. The translation system according to claim 1, identifying a language of a speech received by the directional microphone from a face image of the user obtained by the camera.

3. The translation system according to claim 1 or 2, wherein the another directional speaker is constituted by two or more directional speakers and outputs the another language by adjusting the volume and arrival time differences between the two or more directional speakers as if the sound were generated from the location of the user.

4. The translation system according to any one of claims 1 to 3, comprising at least three sets of the cameras, the directional speakers, and the directional microphones and assigning each of the sets to each user.

5. The translation system according to claim 4, selecting a preset language as the another language and retranslating the selected language.

6. The translation system according to claim 4, selecting a language spoken by the most users as the another language and retranslating the selected language.

7. The translation system according to claim 4, selecting a language inferred from information obtained by the camera as the another language and retranslating the selected language.

8. A translation apparatus outputting sound from a directional speaker on the basis of input from a camera and a directional microphone,
the translation apparatus determining a location of a user from surroundings information obtained by the camera, moving the directional speaker and the directional microphone toward the location of the user, identifying the language of a speech received by the directional microphone, translating the language into another language to output the translated language from another directional speaker, and retranslating the translation in the another language into the language to output the retranslated language from the directional speaker.

9. A translation method for outputting sound from a directional speaker on the basis of input from a camera and a directional microphone, the translation method including:
determining a location of a user from surroundings information obtained by the camera;
moving the directional speaker and the directional microphone toward the location of the user;
identifying the language of a speech received by the directional microphone;
translating the language into another language to output the translated language from another directional speaker; and
retranslating the translation in the another language into the language to output the retranslated language from the directional speaker.

10. A translation program executed by a translation apparatus that outputs sound from a directional speaker on the basis of input from a camera and a directional microphone, the translation program executing:
a process of determining a location of a user from surroundings information obtained by the camera;
a process of moving the directional speaker and the directional microphone toward the location of the user;
a process of identifying the language of a speech received by the directional microphone;
a process of translating the language into another language to output the translated language from another directional speaker; and
a process of retranslating the translation in the another language into the language to output the retranslated language from the directional speaker.
